(19) United States
(12) Patent Application Publication
(10) Pub. No.: US 2026/0212533 A1
(43) Pub. Date: Jul. 23, 2026

(54) LEARNING DEVICE, LEARNING METHOD, AND LEARNING PROGRAM

(71) Applicant: NTT, Inc., Tokyo (JP)

(72) Inventors: Kana KURATA, Tokyo (JP); Mayuko WATANABE, Tokyo (JP); Jun SHIMAMURA, Tokyo (JP); Ryuichi TANIDA, Tokyo (JP)

(73) Assignee: NTT, Inc., Tokyo (JP)

(21) Appl. No.: 19/135,760

(22) PCT Filed: Dec. 7, 2022
(86) PCT No.: PCT/JP2022/045176

§ 371 Date: Jun. 4, 2025

(51) Int. Cl. G06T 7/90; G06T 7/50; G06T 7/73

(52) U.S. Cl. CPC G06T 7/90; G06T 7/50; G06T 7/73; G06T 2207/10024; G06T 2207/10028; G06T 2207/10048; G06T 2207/20081; G06T 2207/20084

(57) ABSTRACT

An acquisition unit of a learning device acquires point information for each pixel from a plurality of learning images observed in different wavelength ranges, the point information having a 5-dimensional array obtained by combining 3-dimensional coordinates of points located on a line of sight and a vector indicating a direction of the line of sight. A learning unit of the learning device learns a density estimation multilayer perceptron that estimates a density estimation value which is an estimation value of a probability that there is a substance generating a signal at a point by using the plurality of learning images and the point information acquired by the acquisition unit from the plurality of learning images.

### TECHNICAL FIELD

The disclosed technology relates to a learning device, a learning method, and a learning program.

Objects reflect, absorb, or transmit electromagnetic waves with different wavelengths depending on types, states, and the like of constituent substances. In other words, it is possible to estimate the type of the substance constituting the object and the distribution of the intensity of a certain feature from the difference in characteristics of reflection, absorption, or transmission of the electromagnetic wave. For example, in certain observation wavelength ranges (specifically, near infrared regions), regions where chlorophyll absorption values are low can be estimated to be regions where the number of plant leaves is relatively large. Wavelength ranges appropriate for observation vary depending on characteristics desired to be estimated or substances desired to be identified. For example, in order to obtain information regarding reflection or absorption according to a composition and a structure of a substance in a case where a light source is sunlight or illumination, observation in a case where a wavelength range is 0 μm to about 6 μm is appropriate. On the other hand, in order to obtain temperature and emissivity information in a case where the light source is blackbody radiation from an object at a general temperature on the earth, observation in a case where the wavelength range is about 7.5 μm to about 10.5 μm is appropriate. A peak wavelength of blackbody radiation based on Wien's displacement law is 10.6 μm at 0° C. and 7.7 μm at 100° C.

In a multispectral image, electromagnetic waves in a plurality of wavelength ranges are recorded. Specifically, for a multispectral image, the presence of characteristics of an object can be estimated by recording reflection or absorption of electromagnetic waves. A multispectral image can be acquired by an image sensor or the like (for example, a multispectral sensor, a hyperspectral sensor, or the like) that has a plurality of observation wavelength ranges. As the observation wavelength range of the sensor, a wavelength range in which an influence of the atmosphere is relatively small and transmittance of light is relatively high (a so-called an atmospheric window) is used relatively often in observation on the earth other than in the field of a meteorology. On the other hand, in observation other than that of the earth, a wavelength range such as X-rays is often used. Hereinafter, the observation wavelength range of the sensor is also referred to as an observation band.

### CITATION LIST

### Non Patent Literature

Non Patent Literature 1: Ben Mildenhall, Pratul P. Srinivasan, Matthew Tancik, Jonathan T. Barron, Ravi Ramamoorthi, Ren Ng “NeRF: Representing Scenes as Neural Radiance Fields for View Synthesis”, 3 Aug. 2020, URL [https://arxiv.org/pdf/2003.08934.pdf].
Non Patent Literature 2: Chen-Hsuan Lin, Wei-Chiu Ma, Antonio Torralba, Simon Lucey “BARF: Bundle-Adjusting Neural Radiance Fields”, 19 Aug. 2021, URL [https://arxiv.org/pdf/2104.06405.pdf].

### SUMMARY OF INVENTION

### Technical Problem

There is a problem that multispectral images captured at an observation band appropriate for each application cannot be easily acquired. Specifically, as methods of acquiring multispectral images, there are methods of using multispectral sensors and methods of combining data acquired by sensors having different observable wavelength ranges. When multispectral images are acquired by using multispectral sensors, there are endless combinations of observation wavelength ranges depending on applications. Therefore, in order to prepare optimal multispectral sensors, the sensors have to be manufactured individually. When observation is carried out only in an optimal wavelength range according to the application, only data with low versatility can be acquired.

On the other hand, when multispectral images are acquired by combining data acquired by sensors having different observable wavelength ranges, alignment of data sets is necessary. Specifically, it is necessary to estimate a positional relationship of the data set by fixing positions of the sensors using dedicated jigs and capturing calibration patterns that can always be observed at any wavelength. The above-described work requires specialized knowledge and advanced skills. in this case, it is necessary to perform work assuming the alignment of the data sets from the time of observation, and it is difficult to freely combine the data sets from an acquired data archive.

The disclosed technology has been made in view of the above points, and an object thereof is to generate a multispectral image by combining data acquired by sensors having different observable wavelength ranges without performing work related to alignment at the time of observation.

### Solution to Problem

According to a first aspect of the present disclosure, a learning device includes: an acquisition unit configured to acquire point information for each pixel from a plurality of learning images observed in different wavelength ranges, the point information having a 5-dimensional array obtained by combining 3-dimensional coordinates of points located on a line of sight and a vector indicating a direction of the line of sight; and a learning unit configured to learn a density estimation multilayer perceptron that estimates a density estimation value which is an estimation value of a probability that there is a substance generating a signal at a point by using the plurality of learning images and the point information acquired by the acquisition unit from the plurality of learning images.

According to a second aspect of the present disclosure, a learning method includes: acquiring, by an acquisition unit, point information for each pixel from a plurality of learning images observed in different wavelength ranges, the point information having a 5-dimensional array obtained by combining 3-dimensional coordinates of points located on a line of sight and a vector indicating a direction of the line of sight; and learning, by a learning unit, a density estimation multilayer perceptron that estimates a density estimation value which is an estimation value of a probability that there is a substance generating a signal at a point by using the plurality of learning images and the point information acquired by the acquisition unit from the plurality of learning images.

According to a third aspect of the present disclosure, a learning program causes a computer to function as each unit included in the learning device.

### Advantageous Effects of Invention

According to the disclosed technology, it is possible to generate a multispectral image by combining data acquired by sensors that have different observable wavelength ranges without performing work related to alignment at the time of observation.

### BRIEF DESCRIPTION OF DRAWINGS

FIG. 1 is a block diagram illustrating an example of a hardware configuration of a learning device.

FIG. 2 is a block diagram illustrating an example of a functional configuration of the learning device.

FIG. 3 is a schematic diagram illustrating an example of a configuration of a DNN in BARF.

FIG. 4 is a diagram illustrating an example of a flow of a process when an image is generated.

FIG. 5 is a diagram illustrating an example of a flow of a process when a density estimation multilayer perceptron, a color estimation multilayer perceptron related to a wavelength range of visible light, and external parameters of a sensor capable of observing the visible light are learned.

FIG. 6 is a diagram illustrating an example of a flow of a process when a density estimation multilayer perceptron, a color estimation multilayer perceptron related to a wavelength range of infrared light, and external parameters of a sensor capable of observing infrared light are learned.

FIG. 7 is a flowchart illustrating a flow of a learning process.

FIG. 8 is a diagram illustrating an example of a flow of a process when an image is generated in a case where a density estimation multilayer perceptron and a color estimation multilayer perceptron have a common multilayer perceptron.

FIG. 9 is a diagram illustrating an example of a flow of a process when a density estimation multilayer perceptron, a color estimation multilayer perceptron related to a wavelength range of visible light, a common multilayer perceptron, and external parameters of a sensor capable of observing visible light are learned in a case where the density estimation multilayer perceptron and the color estimation multilayer perceptron have a common multilayer perceptron.

FIG. 10 is a diagram illustrating an example of a flow of a process when a density estimation multilayer perceptron, a color estimation multilayer perceptron related to a wavelength range of infrared light, a common multilayer perceptron, and external parameters of a sensor capable of observing infrared light are learned in a case where the density estimation multilayer perceptron and the color estimation multilayer perceptron have a common multilayer perceptron.

FIG. 11 is a diagram illustrating an example of a flow of a process when an image is generated from captured images captured by a visible light sensor, an infrared sensor, and an ultraviolet sensor.

### DESCRIPTION OF EMBODIMENTS

Hereinafter, an example of an embodiment of the disclosed technology will be described with reference to the drawings. In the drawings, the same or equivalent constituent elements and portions are denoted by the same reference signs. Dimensional ratios in the drawings are exaggerated for convenience of description and may be different from actual ratios.

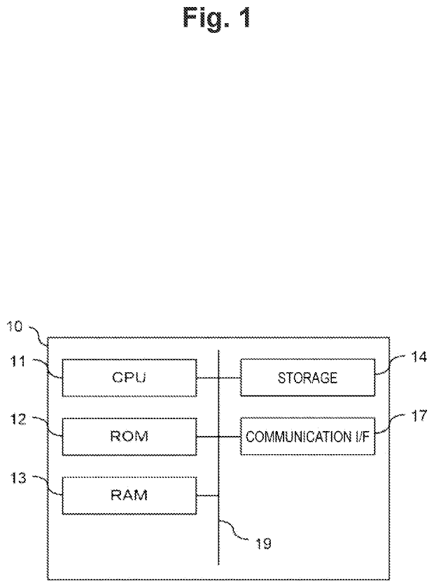

FIG. 1 is a block diagram illustrating a hardware configuration of a learning device 10 according to the present embodiment. As illustrated in FIG. 1, the learning device 10 includes a central processing unit (CPU) 11, a read only memory (ROM) 12, a random access memory (RAM) 13, a storage 14, and a communication interface (I/F) 17. The elements are communicatively connected with each other via a bus 19.

The CPU 11 is a central processing unit that executes various programs and controls each unit. That is, the CPU 11 reads a program from the ROM 12 or the storage 14 and executes the program using the RAM 13 as a working area. The CPU 11 controls each of the elements described above and performs various types of arithmetic processing in accordance with the program stored in the ROM 12 or the storage 14. In the present embodiment, the ROM 12 or the storage 14 stores a learning program for executing a learning process to be described below.

The ROM 12 stores various programs and various types of data. The RAM 13 serving as the working area temporarily stores a program or data. The storage 14 includes a storage device such as a hard disk drive (HDD) or solid state drive (SSD) and stores various programs including an operating system and various types of data.

The communication I/F 17 is an interface for communication with other devices. Wired communication standards such as Ethernet (registered trademark) or FDDI or wireless communication standards such as 4G, 5G, or Wi-Fi (registered trademark) are used for the communication, for example.

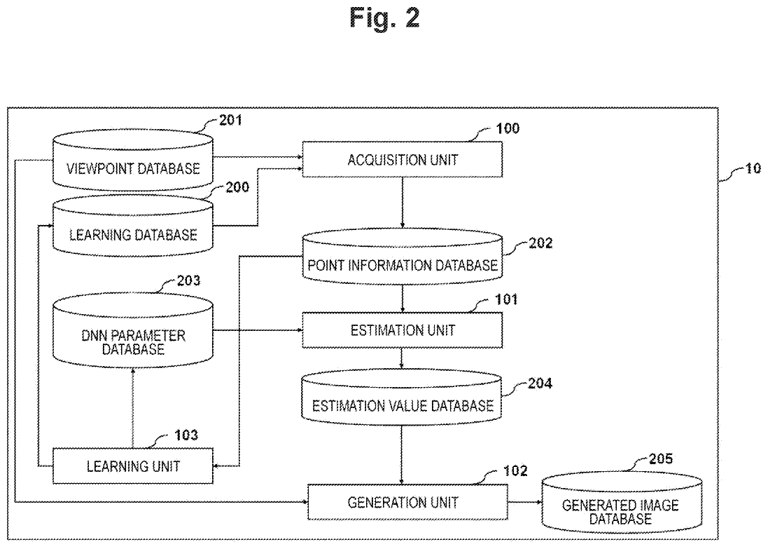

Next, a functional configuration of the learning device 10 will be described. FIG. 2 is a block diagram illustrating an example of a functional configuration of the learning device 10. As illustrated in FIG. 2, the learning device 10 includes an acquisition unit 100, an estimation unit 101, a generation unit 102, and a learning unit 103 as functional elements. Each functional element is realized by the CPU 11 reading a learning program stored in the ROM 12 or the storage 14, loading the learning program on the RAM 13, and executing the learning program. The learning device 10 includes a learning database 200, a viewpoint database 201, a point information database 202, a deep neural network (DNN) parameter database 203, an estimation value database 204, and a generated image database 205.

The acquisition unit 100 acquires point information regarding points located on the line of sight from a plurality of learning images observed in different wavelength ranges. The point information has a 5-dimensional array obtained by combining 3-dimensional coordinates of points located on a line of sight of the sensor and a vector indicating the direction of the line of sight, and is information recorded for each pixel. When the point information is not recorded, the acquisition unit 100 can generate the point information for each pixel based on the image coordinates of each pixel and camera parameters.

In the present embodiment, a situation in which a signal indicating presence is generated without the transmittance near 100% or emissivity near 0% in any observation wavelength range (for example, the brightness is different from the background, or an edge appears) is applied as an observation target of the sensor. Accordingly, for example, an image observed from a wavelength range of ultraviolet light to a wavelength range of thermal infrared light (that is, from about 0.2 μm to about 14.0 μm) from which a signal of reflection and absorption by a surrounding object can be easily ascertained is applied as a learning image. Specifically, in the present embodiment, a wavelength range of visible light (that is, from about 0. 4 μm to about 0.78 μm) and a wavelength range from near infrared light to thermal infrared light (that is, from about 0.78 μm to about 14 μm) are applied as wavelength ranges in which the learning image is observed. Hereinafter, light from near infrared light to thermal infrared light is referred to as infrared light. However, the present invention is not limited to this example. For example, in addition to these wavelength ranges, a wavelength range of ultraviolet light may be applied as the wavelength range in which the learning image is observed. A wavelength range of ultraviolet light and a wavelength range of infrared light may be applied as the wavelength ranges in which the learning image is observed.

Specifically, the acquisition unit 100 reads internal parameters and external parameters of the sensor during capturing of the learning image from the learning database 200. The internal parameters include a focal length of the sensor and a lens distortion coefficient. The internal parameters can be obtained from specification information of the sensor or can be obtained as data from the sensor, The external parameters are parameters indicating a position and an orientation of the sensor. Then, in the external parameters, the positions and the orientations of one set of sensors are automatically estimated for one learning image. An initial value of an external parameter is a random number or the like. The acquisition unit 100 calculates a line-of-sight direction of each pixel from the internal parameters and the external parameters and acquires point information regarding a point located on the line of sight.

Any resolution and any image size of the learning image are set. As an interval and the range of points related to the point information acquired by the acquisition unit 100, values used in neural radiance fields (NeRf), bundle-adjusting neural radiance fields (BARF), or general volume rendering are set. Details of the NeRf and the BARE will be described below. The acquisition unit 100 stores the point information acquired for a plurality of learning images observed in different wavelength ranges in the point information database 202.

The acquisition unit 100 acquires the point information for each pixel from captured images captured by a plurality of sensors (hereinafter simply referred to as a “plurality of sensors”) that have different observable wavelength ranges. In the present embodiment, as the plurality of sensors, a visible light sensor that has an observation band in a wavelength range of about 0.4 μm to about 0.78 μm and an infrared sensor that has an observation band in a wavelength range of about 0,78 μm to about 14 μm are applied. However, the present invention is not limited to this example. For example, as the plurality of sensors, in addition to these sensors, an ultraviolet sensor or the like that has an observation band in a wavelength range of about 0.2 μm to about 0.4 μm may be applied. An ultraviolet sensor and an infrared sensor may be applied as the plurality of sensors.

Specifically, the acquisition unit 100 reads the viewpoint information from the viewpoint database 201. The viewpoint information is internal parameters and external parameters of the sensors when the captured images are captured. The acquisition unit 100 calculates a line-of-sight direction of each pixel from the viewpoint information and acquires point information regarding points located on the line of sight. Any resolution and any image size of the captured image are set. The interval and the range of the points related to the point information acquired by the acquisition unit 100 are set to values used in the NeRf, the BARF, or general volume rendering. The acquisition unit 100 stores the point information acquired from the captured image in the point information database 202.

The estimation unit 101 estimates the density estimation value by inputting the point information acquired from the captured image by the acquisition unit 100 to the density estimation multilayer perceptron. Specifically, the estimation unit 101 reads the point information acquired from the captured image by the acquisition unit 100 from the point information database 202. Then, the estimation unit 101 estimates the density estimation value by inputting the point information acquired from the captured image by the acquisition unit 100 to the density estimation multilayer perceptron. The density estimation value is an estimation value of a probability that there is a substance generating a signal. When the density estimation value is high, the probability that there is a substance generating a signal is high. When a common object is shown in any captured image, it is assumed that a place where a density estimation value is high is common. The parameters of the density estimation multilayer perceptron are stored in the DNN parameter database 203.

The density estimation multilayer perceptron is a multilayer perceptron (MLP) that estimates a density estimation value. The density estimation multilayer perceptron is learned by the learning unit 103.

The estimation unit 101 estimates a color estimation value in the specific wavelength range by inputting the point information acquired from the captured image captured by the sensor capable of observing the specific wavelength range to the color estimation multilayer perceptron related to the specific wavelength range. Specifically, the estimation unit 101 estimates the color estimation value by inputting, among the point information stored in the point information database 202, point information acquired from a captured image captured by a sensor capable of observing a specific wavelength range to the color estimation multilayer perceptron related to the specific wavelength range. The parameter of the color estimation multilayer perceptron is stored in the DNN parameter database 203 for each wavelength range.

The color estimation multilayer perceptron is a multilayer perceptron that estimates a color estimation value. The color estimation multilayer perceptron is independent of the density estimation multilayer perceptron. The color estimation multilayer perceptron is learned by the learning unit 103.

For example, the estimation unit 101 estimates RGB values of the points related to the point information by inputting the point information acquired from the captured image captured by the visible light sensor to the color estimation multilayer perceptron related to the wavelength range of the visible light. The estimation unit 101 estimates reflection luminance or the like in the wavelength range of the points related to the point information by inputting the point information acquired from the captured image captured by the infrared sensor to the color estimation multilayer perceptron related to the wavelength range of the infrared light.

The estimation unit 101 stores the density estimation value and the color estimation value for each wavelength range in the estimation value database 204. For example, when the specific wavelength range is a wavelength range of the visible light, the estimation unit 101 stores the RGB values and a density estimation value o in the estimation value database 204. When the specific wavelength range is a wavelength range of the infrared light, the estimation unit 101 stores the reflection luminance and a density estimation value o in the wavelength range in the estimation value database 204.

The generation unit 102 generates an image observed in the specific wavelength range based on the density estimation value estimated by the estimation unit 101 and the color estimation value in the specific wavelength range. Specifically, the generation unit 102 reads the density estimation value and the color estimation value in a specific wavelength range from the estimation value database 204. The generation unit 102 reads an external parameter of a sensor capable of observing the specific wavelength range from the viewpoint database 201.

The generation unit 102 generates an image observed in the specific wavelength range by executing volume rendering using the density estimation value and the color estimation value in the specific wavelength range. For example, when the specific wavelength range is the wavelength range of the visible light, the generation unit 102 combines RGB values and the density estimation value o and acquires the RGB values in each pixel. In the present embodiment, a scheme used in volume rendering, such as a ray tracing method, is used as a scheme of combining the RGB values and the density estimation value o. The generation unit 102 stores the generated image in the generated image database 205.

The learning unit 103 learns the density estimation multilayer perceptron by using the point information acquired by the acquisition unit 100 from the plurality of learning images and the plurality of learning images. Furthermore, the learning unit 103 learns the color estimation multilayer perceptron related to the specific wavelength range using the point information acquired from the learning image observed in the specific wavelength range and the learning image observed in the specific wavelength range. The learning unit 103 stores parameters of the learned density estimation multilayer perceptron and color estimation multilayer perceptron in the DNN parameter database 203.

The learning unit 103 optimizes the external parameter of the sensor capable of observing the specific wavelength range simultaneously with the learning process using the point information acquired from the learning image observed in the specific wavelength range and the learning image observed in the specific wavelength range. The learning unit 103 stores the learned external parameter of the sensor capable of observing the specific wavelength range in the learning database 200.

For example, when the point information acquired from the learning image observed in the wavelength range of the visible light and the point information acquired from the learning image observed in the wavelength range of the infrared light are stored in the point information database 202, the learning unit 103 inputs the point information to the density estimation multilayer perceptron. Then, the learning unit 103 estimates the density estimation value. The learning unit 103 estimates the color estimation value in the wavelength range of the visible light by inputting the point information acquired from the learning image observed in the wavelength range of the visible light to the color estimation multilayer perceptron related to the wavelength range of the visible light.

The learning unit 103 generates an image observed in the wavelength range of the visible light based on the estimated density estimation value and the color estimation value in the wavelength range of the visible light. The learning unit 103 calculates an error between the generated image and the learning image observed in the wavelength range of the visible light. The learning unit 103 sets the error as a loss and learns the density estimation multilayer perceptron, the color estimation multilayer perceptron related to the wavelength range of the visible light, and the external parameter of the sensor capable of observing the visible light. In other words, the learning unit 103 does not learn the color estimation multilayer perceptron related to the wavelength range of the infrared light from the error between the generated image and the learning image observed in the wavelength range of the visible light. Setting of differentiation to the external parameter, a loss calculation formula, and an optimization algorithm conform to a method known as a technique related to the BARF.

The learning unit 103 estimates the color estimation value in the wavelength range of the infrared light by inputting the point information acquired from the learning image observed in the wavelength range of the infrared light to the color estimation multilayer perceptron related to the wavelength range of the infrared light. The learning unit 103 generates an image observed in the wavelength range of the infrared light based on the estimated density estimation value and the color estimation value in the wavelength range of the infrared light. The learning unit 103 calculates an error between the generated image and the learning image observed in the wavelength range of the infrared light. The learning unit 103 learns the density estimation multilayer perceptron, the color estimation multilayer perceptron related to the wavelength range of the infrared light, and the external parameter of the sensor capable of observing the infrared light using the error as a loss. In other words, the learning unit 103 does not learn the color estimation multilayer perceptron related to the wavelength range of the visible light from the error between the generated image and the learning image observed in the wavelength range of the infrared light. Setting of differentiation to the external parameter, a loss calculation formula, and an optimization algorithm conform to a method known as a technique related to the BARF.

The learning unit 103 learns the color estimation multilayer perceptron for each of the plurality of wavelength ranges in a changeable order. Accordingly, the learning unit 103 may alternately learn the color estimation multilayer perceptron related to the wavelength range of the infrared light and the color estimation multilayer perceptron related to the wavelength range of the visible light. The learning unit 103 may preferentially perform learning from the color estimation multilayer perceptron of the wavelength range related to the image with a higher resolution.

In the present embodiment, the learning unit 103 learns the density estimation multilayer perceptron and the color estimation multilayer perceptron by applying the BARF that does not require an input of the external parameter. However, the present invention is not limited to this example. Of the schemes of generating images in which 3-dimensional spaces are represented by density and color and observed from any viewpoint, other methods that do not require inputs of the external parameters during earning of the DNN may be applied.

The BARF is a scheme based on the NeRf. In the NeRf, an image observed from any viewpoint is generated by performing volume rendering on a vector field (radiance field) in which density and color are associated with each other. Specifically, in the NeRf, point information acquired from the captured image captured by the sensor is input to the DNN. Then, the DNN outputs the color and the density of the points related to the input point information. In the NeRf, the color and the density output from the DNN are integrated to generate an image observed from any viewpoint.

In the NeRf, the DNN is learned using a set of images captured from a plurality of viewpoints, the internal parameters of the sensors, and the external parameters of the sensors as an input. Specifically, the point information acquired from the learning image is input to the DNN during learning. The DNN outputs the color and the density at the points related to the input point information. The DNN is learned by calculating a difference between the image generated by integrating the color and the density output from the DNN and the learning image.

On the other hand, the BARF is a scheme in which it is not necessary to input the external parameter of the sensor during learning of the DNN, unlike the NeRf. This is because the external parameter of the sensor is automatically estimated during learning of the DNN. In other words, in the BARF, the DNN is learned using a set of the learning image and the internal parameter of the sensor as an input.

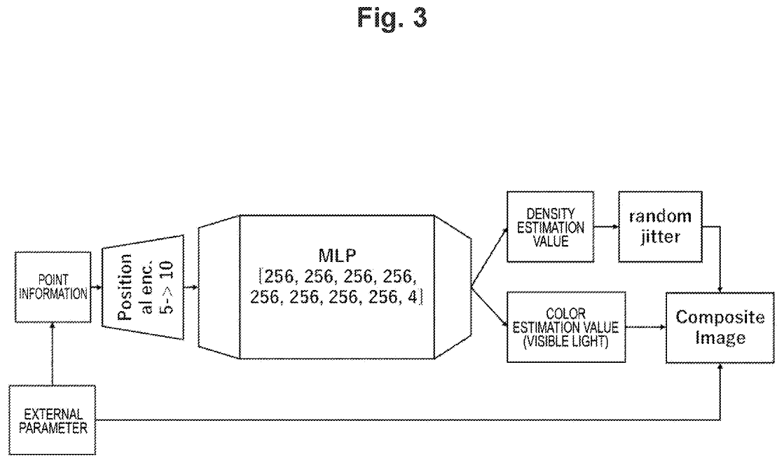

FIG. 3 illustrates a configuration of the DNN in the BARF. As illustrated in FIG. 3, the point information acquired from the captured image captured by the visible light sensor is input to the multilayer perceptron included in the DNN. Then, the multilayer perceptron outputs a color estimation value and a density estimation value in the wavelength range of the visible light. An image observed in the wavelength range of the visible light is generated from the color estimation value and the density estimation value. Numbers described in the multilayer perceptron in FIG. 3 indicate examples of the number of channels of each layer.

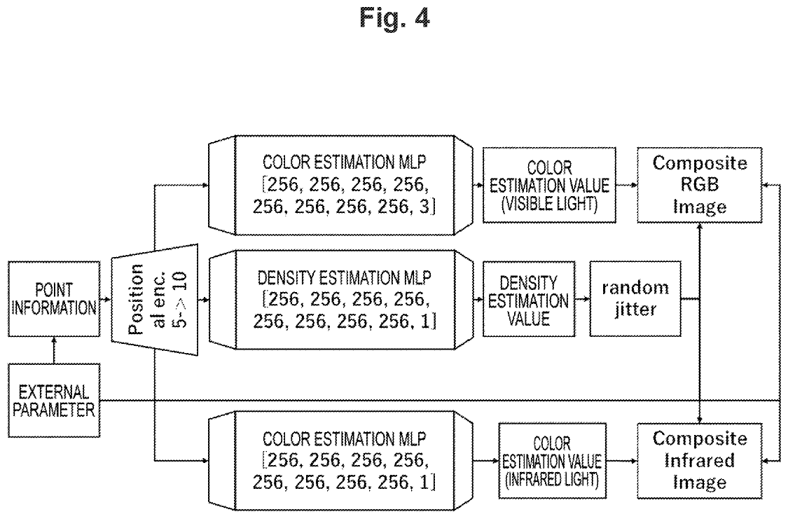

FIG. 4 illustrates a flow of a process when an image is generated in the present embodiment. As illustrated in FIG. 4, the DNN according to the present embodiment separately has a density estimation multilayer perceptron and a color estimation multilayer perceptron. The DNN according to the present embodiment includes a color estimation multilayer perceptron independent for each wavelength range. The color estimation value of the point related to the point information in the wavelength range of the visible light is estimated by inputting the point information acquired from the captured image captured by the visible light sensor to the color estimation multilayer perceptron related to the wavelength range of the visible light. The color estimation value in the wavelength range of the point related to the point information is estimated by inputting the point information acquired from the captured image captured by the infrared sensor to the color estimation multilayer perceptron related to the wavelength range of the infrared light. The density estimation value is estimated by inputting the point information acquired from the captured image captured by the visible light sensor and the point information acquired from the captured image captured by the infrared sensor to the density estimation multilayer perceptron. An image observed in the wavelength range of the visible light is generated from the color estimation value and the density estimation value in the wavelength range of the visible light. An image observed in the wavelength range of the infrared light is generated from the color estimation value and the density estimation value in the wavelength range of the infrared light.

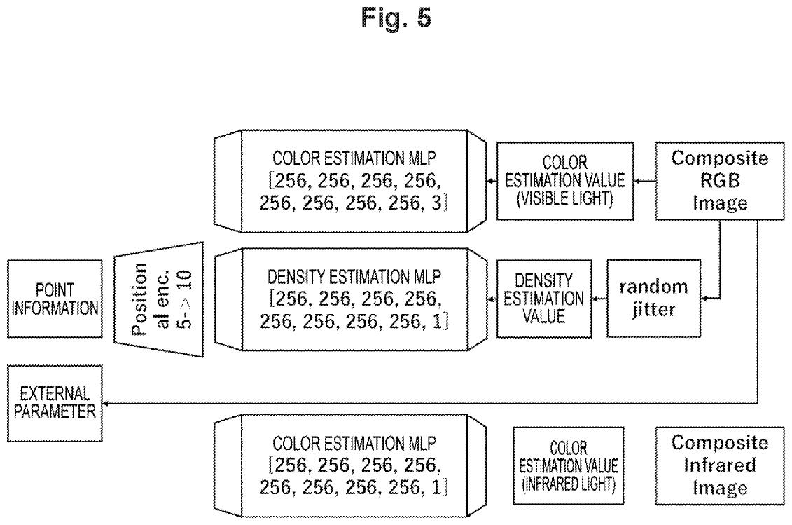

FIG. 5 illustrates a flow of a process when the density estimation multilayer perceptron, the color estimation multilayer perceptron related to the wavelength range of the visible light, and the external parameters of the sensor capable of observing the visible light are learned. As illustrated in FIG. 5, the learning unit 103 learns the density estimation multilayer perceptron, the color estimation multilayer perceptron related to the wavelength range of the visible light, and the external parameters of the sensor capable of observing the visible light from the generated image observed in the wavelength range of the visible light. In this case, the learning unit 103 does not learn the color estimation multilayer perceptron related to the wavelength range of the infrared light.

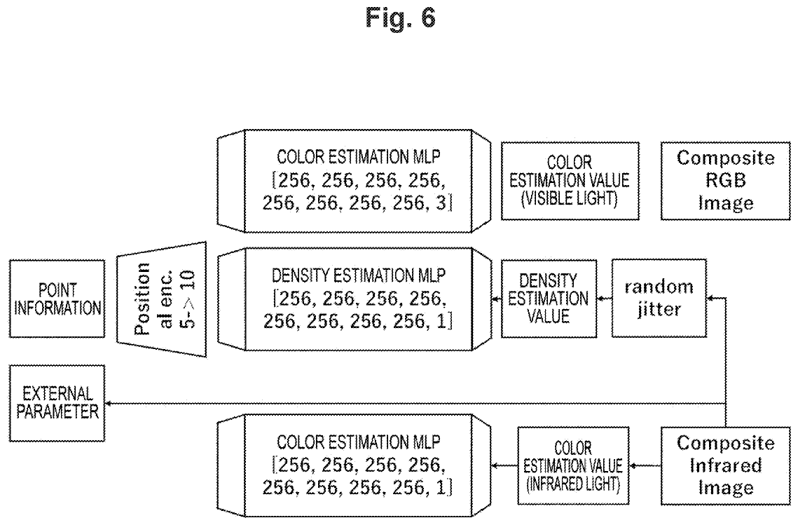

FIG. 6 illustrates a flow of a process when the density estimation multilayer perceptron, the color estimation multilayer perceptron related to the wavelength range of the infrared light, and the external parameters of the sensor capable of observing the infrared light are learned. As illustrated in FIG. 6, the learning unit 103 learns the density estimation multilayer perceptron, the color estimation multilayer perceptron related to the wavelength range of the infrared light, and the external parameters of the sensor capable of observing infrared light from the image observed in the generated wavelength range of the infrared light. In this case, the learning unit 103 does not learn the color estimation multilayer perceptron related to the wavelength range of the visible light.

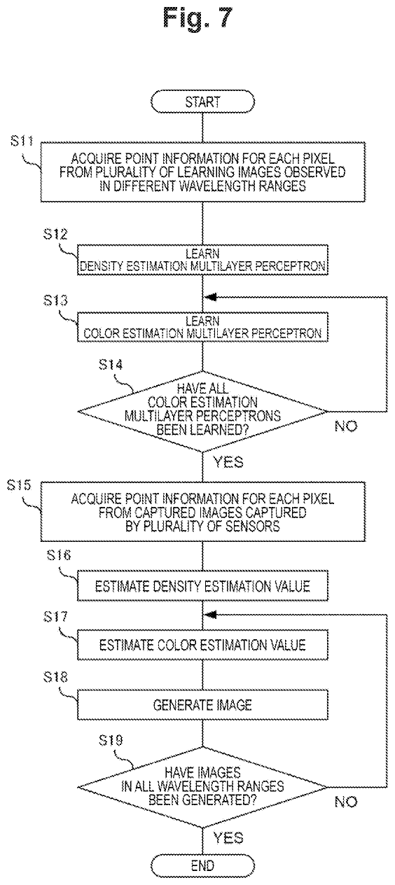

Next, operational effects of the learning device 10 will be described. FIG. 7 is a flowchart illustrating a flow of a learning process by the learning device 10. The CPU 11 reads a learning program from the ROM 12 or the storage 14, loads the learning program on the RAM 13 to execute the learning program.

In step S11, the CPU 11 serving as the acquisition unit 100 acquires the point information regarding the points located on the line of sight for each pixel from a plurality of learning images observed in different wavelength ranges.

Subsequently, in step S12, the CPU 11 serving as the learning unit 103 learns the density estimation multilayer perceptron using the point information acquired from the plurality of learning images and the plurality of learning images.

Subsequently, in step S13, the CPU 11 serving as the learning unit 103 learns the color estimation multilayer perceptron related to the specific wavelength range using the point information acquired from the learning image observed in the specific wavelength range and the learning image observed in the specific wavelength range.

Subsequently, in step S14, the CPU 11 serving as the learning unit 103 determines whether all the color estimation multilayer perceptrons have been learned. When all the color-estimated multilayer perceptrons are learned (step S14: YES), the CPU 11 moves to step S15. Conversely, when all the color estimation multilayer perceptrons are not learned (step S14: NO), the CPU 11 returns to step S13.

Subsequently, in step S15, the CPU 11 serving as the acquisition unit 100 acquires the point information for each pixel from the captured images captured by the plurality of sensors.

Subsequently, in step S16, the CPU 11 serving as the estimation unit 101 can estimate the density estimation value by inputting the point information acquired from the captured image in step S15 to the density estimation multilayer perceptron.

Subsequently, in step S17, the CPU 11 serving as the estimation unit 101 estimates the color estimation value in the specific wavelength range by inputting the point information acquired from the captured image captured by the sensor capable of observing the specific wavelength range to the color estimation multilayer perceptron related to the specific wavelength range.

Subsequently, in step S18, the CPU 11 serving as the generation unit 102 generates an image observed in the specific wavelength range based on the estimated density estimation value and the color estimation value in the specific wavelength range.

Subsequently, in step S19, the CPU 11 serving as the generation unit 102 determines whether images in all wavelength ranges have been generated. When the images in all the wavelength ranges are generated (step S19: YES), the CPU 11 ends the learning process. Conversely, when the images in all the wavelength ranges are not generated (step S19: NO), the CPU 11 returns to step S17.

Here, as a method of acquiring a multispectral image, there is a method of using a hyperspectral sensor. The hyperspectral sensor has a high wavelength resolution and has characteristics that fine spectral features can be ascertained. The observation band is 1 band for a single-wavelength sensor, the observation bands is 3 bands for a visible light sensor, the observation bands are about 20 bands for a multispectral sensor, and the observation bands are about 100 bands for a hyperspectral sensor. However, when the resolution is high, an amount of light received per pixel and imaging becomes small. Therefore, noise relatively increases. In the observation by electromagnetic waves, there is a trade-off of a wavelength resolution, a spatial resolution, and a time resolution with respect to an SN ratio. Since the hyperspectral sensor has a relatively high wavelength resolution, it is necessary to lower the spatial resolution and the temporal resolution in order to keep the SN ratio equal to or higher than a reference. In order to lower the spatial resolution, it is necessary to lower the resolution. However, when the resolution is lowered, a fine spatial pattern is lost unless imaging is performed at a short distance. In order to lower the temporal resolution, it is necessary to increase the exposure time. However, when the exposure time is increased, it is necessary to fix the sensor and take countermeasures for reflection of a mobile object. Accordingly, when the hyperspectral sensor is applied, there is a problem that the spatial resolution and the temporal resolution are lowered or a problem that noise increases.

When a multispectral image is acquired by combining data acquired by sensors that have different observable wavelength ranges, alignment of data sets is necessary. in this case, it is necessary to perform work assuming the alignment of the data sets from the time of observation, and it is difficult to freely combine the data sets from an acquired data archive.

Accordingly, the acquisition unit of the learning device according to the present embodiment acquires point information for each pixel from a plurality of learning images observed in different wavelength ranges, the point information having a five-dimensional array obtained by combining 3-dimensional coordinates of points located on a line of sight and a vector indicating a direction of the line of sight. Then, the learning unit of the learning device according to the present embodiment learns a density estimation multilayer perceptron that estimates a density estimation value which is an estimation value of a probability that there is a substance generating a signal at the point by using the plurality of learning images and the point information acquired by the acquisition unit from the plurality of learning images. As a result, it is possible to generate a multispectral image by combining data acquired by the sensors that have different observable wavelength ranges without performing work related to alignment during observation.

### Modification

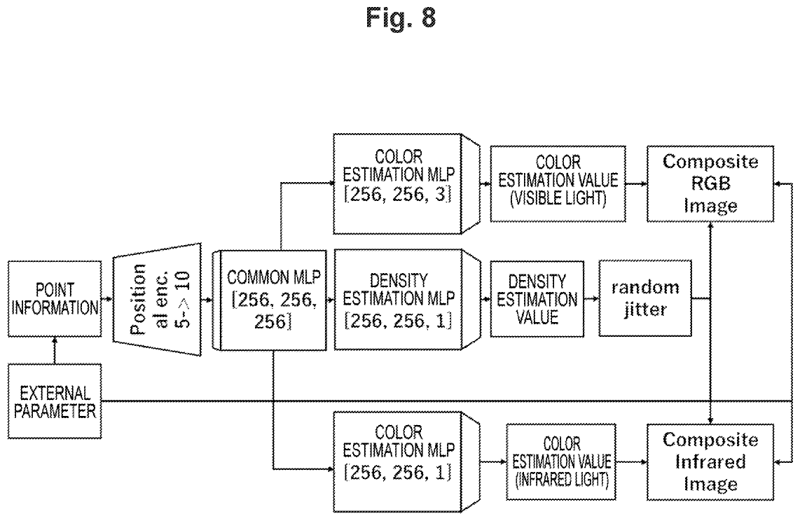

In the above embodiment, the density estimation multilayer perceptron and the color estimation multilayer perceptron do not have a common multilayer perceptron. However, the present invention is not limited to this example. For example, as illustrated in FIG. 8, the multilayer perceptrons may have a common multilayer perceptron that is partially common. That is, the color estimation multilayer perceptron and the density estimation perceptron may be branched in the middle of the common multilayer perceptron. In this case, the common multilayer perceptron may have eight layers, and the color estimation perceptron for each sensor may have one layer.

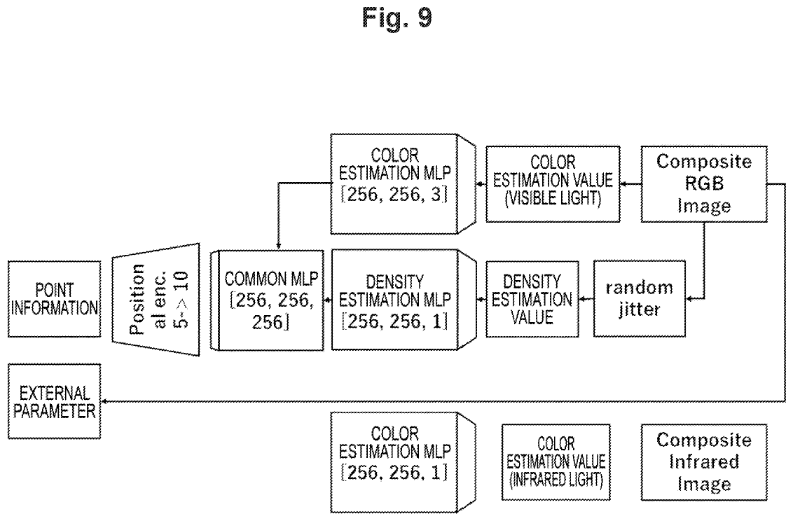

FIG. 9 illustrates a flow of a process when the density estimation multilayer perceptron, the color estimation multilayer perceptron related to the wavelength range of visible light, the common multilayer perceptron, and the external parameters of the sensor capable of observing visible light are learned in a case where the multilayer perceptrons have a common multilayer perceptron. As illustrated in FIG. 9, the learning unit 103 learns the density estimation multilayer perceptron, the color estimation multilayer perceptron related to the wavelength range of the visible light, the common multilayer perceptron, and the external parameters of the sensor capable of observing the visible light from the generated image observed in the wavelength range of the visible light. In this case, the learning unit 103 does not learn the color estimation multilayer perceptron related to the wavelength range of the infrared light.

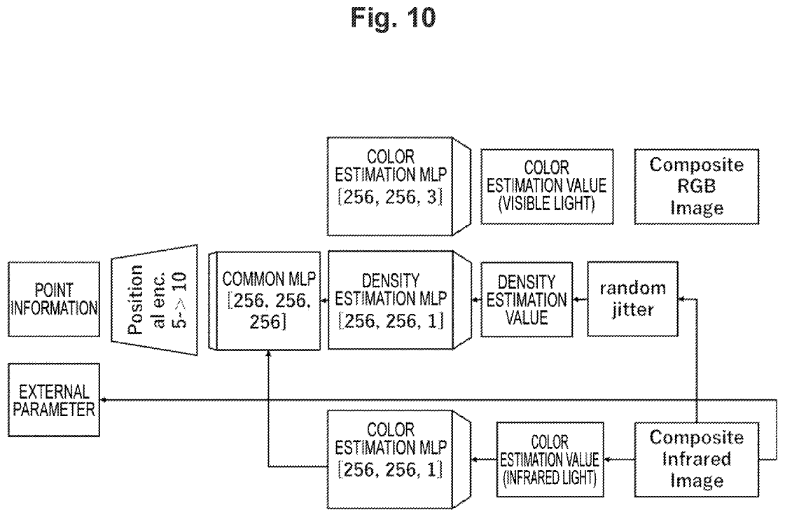

FIG. 10 illustrates a flow of a process when the density estimation multilayer perceptron, the color estimation multilayer perceptron related to the wavelength range of the infrared light, the common multilayer perceptron, and the external parameters of the sensor capable of observing the infrared light are learned in a case where the density estimation multilayer perceptron and the color estimation multilayer perceptron have the common multilayer perceptron. As illustrated in FIG. 10, the learning unit 103 learns the density estimation multilayer perceptron, the color estimation multilayer perceptron related to the wavelength range of the infrared light, the common multilayer perceptron, and the external parameters of the sensor capable of observing infrared light from the generated image observed in the wavelength range of the infrared light. In this case, the learning unit 103 does not learn the color estimation multilayer perceptron related to the wavelength range of the visible light.

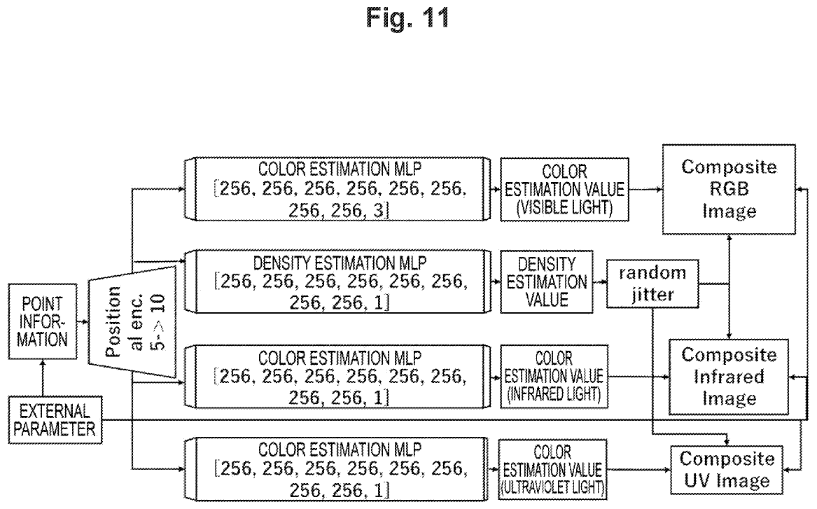

The learning device 10 may generate a new image from a captured image captured by a sensor in another wavelength range in addition to the visible light sensor and the infrared sensor. For example, the new image may be generated from a captured image captured by the ultraviolet sensor. FIG. 11 illustrates a flow of a process when an images is generated from a captured image captured by the ultraviolet sensor in addition to the visible light sensor and the infrared sensor. As illustrated in FIG. 11, the color estimation value of the point related to the point information in the wavelength range of the ultraviolet light is estimated by inputting the point information acquired from the captured image captured by the ultraviolet sensor to the color estimation multilayer perceptron related to the wavelength range of the ultraviolet light. In the multilayer perceptron that performs learning based on the point information acquired from the captured image captured by the visible light sensor, the point information acquired from the captured image captured by the infrared sensor, and the point information acquired from the captured image captured by the ultraviolet sensor, the density estimation value is estimated by inputting the point information generated for a desired angle of field to the density estimation multilayer perceptron. Then, an image observed in the wavelength range of the ultraviolet light is generated from the color estimation value and the density estimation value in the wavelength range of the ultraviolet light.

In the above embodiment, the learning device 10 includes the estimation unit 101 and the generation unit 102. However, the present invention is not limited to this example. The learning device 10 need not include the estimation unit 101 and the generation unit 102.

The learning process executed by the CPU reading software (program) in the above embodiment may be executed by any of various processors other than the CPU. Examples of the processors in this case include a programmable logic device (PLD) in which a circuit configuration can be changed after manufacturing, such as a field-programmable gate array (FPGA) and a dedicated electric circuit that is a processor having a circuit configuration exclusively designed for executing a specific process, such as an application specific integrated circuit (ASIC). The learning process may be executed by one of these various processors or may be executed by combining two or more processors of the same or different types (for example, a plurality of FPGAs, a combination of a CPU and an FPGA, or the like). A hardware structure of any of the various processors is, more specifically, an electric circuit in which circuit elements such as semiconductor elements are combined.

In the above embodiment, the aspect in which the learning program is stored (installed) in advance in the ROM 12 or the storage 14 has been described, but the present invention is not limited thereto. The program may be provided in a form stored in a non-transitory storage medium such as a compact disk read only memory (CD-ROM), a digital versatile disk read only memory (DVD-ROM), or a universal serial bus (USB) memory. The program may be downloaded from an external device via a network.

With regard to the above embodiment, the following supplements are further disclosed.

### (Supplement 1)

A learning device including:
a memory; and
at least one processor connected to the memory,
wherein the processor
acquires point information for each pixel from a plurality of learning images observed in different wavelength ranges, the point information having a 5-dimensional array obtained by combining 3-dimensional coordinates of points located on a line of sight and a vector indicating a direction of the line of sight, and
learns a density estimation multilayer perceptron that estimates a density estimation value which is an estimation value of a probability that there is a substance generating a signal at a point by using the plurality of learning images and the point information acquired by the acquisition unit from the plurality of learning images.

### (Supplement 2)

A non-transitory recording medium storing a program that causes a computer to be able to execute a learning process,
wherein the learning process includes:
acquiring point information for each pixel from a plurality of learning images observed in different wavelength ranges, the point information having a 5-dimensional array obtained by combining 3-dimensional coordinates of points located on a line of sight and a vector indicating a direction of the line of sight; and
learning a density estimation multilayer perceptron that estimates a density estimation value which is an estimation value of a probability that there is a substance generating a signal at a point by using the plurality of learning images and the point information acquired by the acquisition unit from the plurality of learning images.

### REFERENCE SIGNS LIST

10 Learning device
11 CPU
12 ROM
13 RAM
14 Storage
17 Communication I/F
19 Bus
100 Acquisition unit
101 Estimation unit
102 Generation unit
103 Learning unit
200 Learning database
201 Viewpoint database
202 Point information database
203 DNN parameter database
204 Estimation value database
205 Generated image database

1. A learning device comprising:
an acquisition unit configured to acquire point information for each pixel from a plurality of learning images observed in different wavelength ranges, the point information having a 5-dimensional array obtained by combining 3-dimensional coordinates of points located on a line of sight and a vector indicating a direction of the line of sight; and
a learning unit configured to learn a density estimation multilayer perceptron that estimates a density estimation value which is an estimation value of a probability that there is a substance generating a signal at a point by using the plurality of learning images and the point information acquired by the acquisition unit from the plurality of learning images.

2. The learning device according to claim 1, wherein the learning unit estimates a color estimation value of the point in a specific wavelength range and learns a color estimation multilayer perceptron independent of the density estimation multilayer perceptron by using the point information acquired by the acquisition unit from the learning image observed in the specific wavelength range and the learning image observed in the specific wavelength range.

3. The learning device according to claim 2, wherein the learning unit learns the color estimation multilayer perceptron for every plurality of wavelength ranges in a changeable order.

4. The learning device according to claim 1, wherein the plurality of learning images are a learning image observed in a wavelength range of visible light and a learning image observed in a wavelength range from near infrared light to thermal infrared light.

5. The learning device according to claim 2,
wherein the acquisition unit acquires the point information for each pixel from captured images captured by a plurality of sensors that have different observable wavelength ranges, and
wherein the learning device further comprises:
an estimation unit configured to estimate the density estimation value by inputting the point information acquired from the captured image by the acquisition unit to the density estimation multilayer perceptron and to estimate the color estimation value in the specific wavelength range by inputting the point information acquired from the captured image captured by a sensor capable of observing the specific wavelength range to the color estimation multilayer perceptron related to the specific wavelength range; and
a generation unit configured to generate an image observed in the specific wavelength range based on the density estimation value estimated by the estimation unit and the color estimation value in the specific wavelength range.

6. A learning method comprising:
acquiring, by an acquisition unit, point information for each pixel from a plurality of learning images observed in different wavelength ranges, the point information having a 5-dimensional array obtained by combining 3-dimensional coordinates of points located on a line of sight and a vector indicating a direction of the line of sight; and
learning, by a learning unit, a density estimation multilayer perceptron that estimates a density estimation value which is an estimation value of a probability that there is a substance generating a signal at a point by using the plurality of learning images and the point information acquired by the acquisition unit from the plurality of learning images.

7. A learning program causing a computer to function as each unit included in the learning device according to any one of claims 1 to 5.
